(19) United States
(12) Patent Application Publication
(10) Pub. No.: US 2014/0001852 A1
(43) Pub. Date: Jan. 2, 2014

(54) POWER SEQUENCE CIRCUIT

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: YUN BAI, Shenzhen (CN); SONG-LIN TONG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/886,289

(22) Filed: May 3, 2013

(30) Foreign Application Priority Data
Jun. 29, 2012 (CN) 2012102207093

(51) Int. Cl. G05F 1/66

(52) U.S. Cl. CPC G05F 1/66
USPC 307/38

(57) ABSTRACT

A power sequence circuit includes a control circuit and a plurality of output circuits. The control circuit provides a plurality of power-on signals and a plurality of power-off signals according to a power-on sequence and a power-off sequence. Each of the output circuits provides an output voltage when receiving a corresponding one of the power-on signals, and stops providing the output voltage when receiving a corresponding one of the power-off signals. The power sequence circuit controls the output voltages by the power-on sequence and the power-off sequence.

### BACKGROUND

1. Technical Field

The present disclosure relates to a power sequence circuit, and particularly to a power sequence circuit for controlling a power sequence.

2. Description of Related Art

When a motherboard is designed the power demand of the motherboard must be tested. However, when the motherboard being tested needs a plurality of power sources, it is difficult to control power sequence of a plurality of power sources manually with a tester. Hence, the power sequence of the motherboard with a plurality of power sources cannot be easily measured manually with a tester.

Therefore, there is need for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a power sequence circuit of the present disclosure.

FIGS. 2-3 are circuit diagrams of an embodiment of a control circuit of a power sequence circuit of the present disclosure.

FIGS. 4-6 are circuit diagrams of an embodiment of a first output circuit of a power sequence circuit of the present disclosure.

FIGS. 7-8 are circuit diagrams of an embodiment of a third output circuit of a power sequence circuit of the present disclosure.

FIG. 9 is a circuit diagram of an embodiment of a display circuit of a power sequence circuit of the present disclosure.

### DETAILED DESCRIPTION

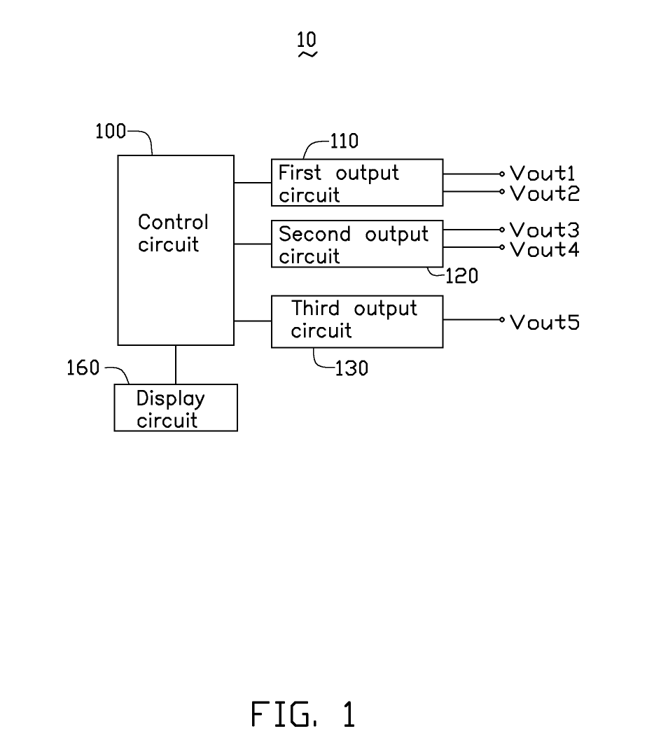

FIG. 1 shows an embodiment of a power sequence circuit 10. The power sequence circuit 10 includes a control circuit 100, a plurality of output circuits, and a display circuit 160. In the embodiment, the power sequence circuit 10 includes first to third output circuits 110-130 and is utilized to provide output voltages to a motherboard for testing power demand of the motherboard.

The control circuit 100 provides a plurality of power-on signals to the plurality of output circuits. In the embodiment, the control circuit 100 provides first to fifth power-on signals to the first to third output circuits 110-130 according to a power-on sequence. The first output circuit 110 receives the first and second power-on signals, provides a first output voltage Vout1 when receiving the first power-on signal, and provides a second output voltage Vout2 when receiving the second power-on signal. The second output circuit 120 receives the third and fourth power-on signals, provides a third output voltage Vout3 when receiving the third power-on signal, and provides a fourth output voltage Vout4 when receiving the fourth power-on signal. The third circuit 130 receives the fifth power-on signal, and provides a fifth output voltage Vout5 when receiving the fifth power-on signal. In the embodiment, the first to third output circuits 110-130 provide a plurality of output currents when receiving the first to fifth power-on signals. In addition, the control circuit 100 provides a plurality of power-off signals to the plurality of output circuits. In the embodiment, the control circuit 100 provides first to fifth power-off signals to the first to third output circuits 110-130 according to a power-off sequence. The first output circuit 110 receives the first and second power-off signals, stops providing the first output voltage Vout1 when receiving the first power-off signal, and stops providing the second output voltage Vout2 when receiving the second power-off signal. The second output circuit 120 receives the third and fourth power-off signals, stops providing the third output voltage Vout3 when receiving the third power-off signal, and stops providing the fourth output voltage Vout4 when receiving the fourth power-off signal. The third circuit 130 receives the fifth power-off signal, and stops providing the fifth output voltage Vout5 when receiving the fifth power-off signal.

When the control circuit 100 provides the plurality of power-on signals to the plurality of output circuits according to the power-on sequence, the control circuit 100 also provides a plurality of enable signals to the plurality of output circuits. For example, the control circuit 100 provides the first power-on signal and an enable signal to the first output circuit 110 at the same time. In the embodiment, the control circuit 100 provides first to third enable signals to the first to third output circuits 110-130. The first to third output circuits 110-130 receive the first to third enable signals to provide preset values of the first to fifth output voltages Vout1-Vout5. In addition, the first to third output circuits 110-130 provide a plurality of feedback signals to the control circuit 100 when the first to third output circuits 110-130 provides the first to fifth output voltages Vout1-Vout5. Thus, the control circuit 100 can know that the first to fifth output voltages Vout1-Vout5 have been provided.

The control circuit 100 detects the plurality of output voltages and output currents of the first to third output circuits 110-130, and shows the plurality of output voltages, the plurality of output currents, and the power-on sequence of the plurality of output voltages to users through the display circuit 160. In addition, the control circuit 100 can further show the power-off sequence of the plurality of output voltages to users through the display circuit 160.

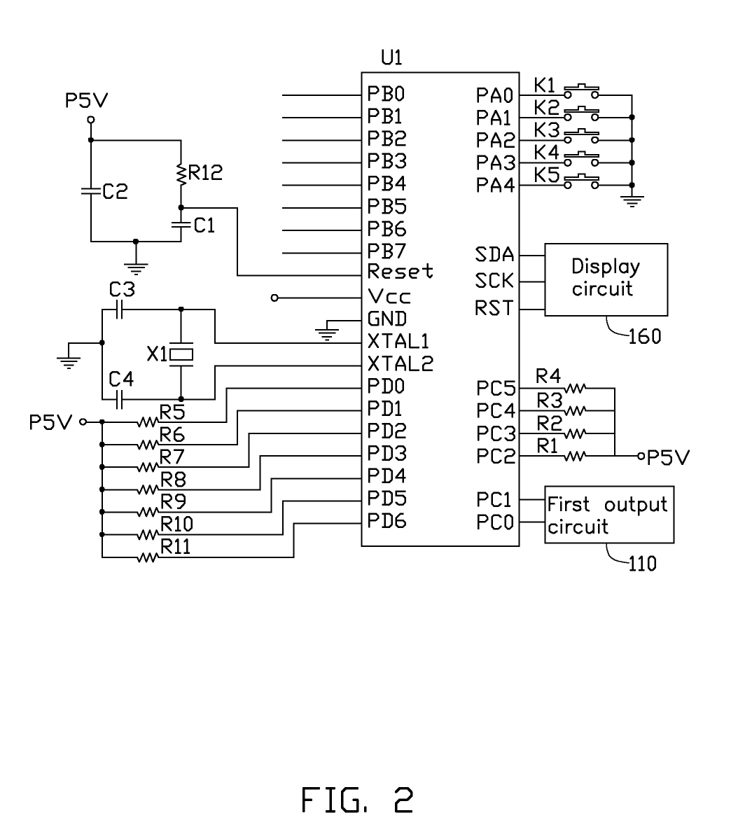

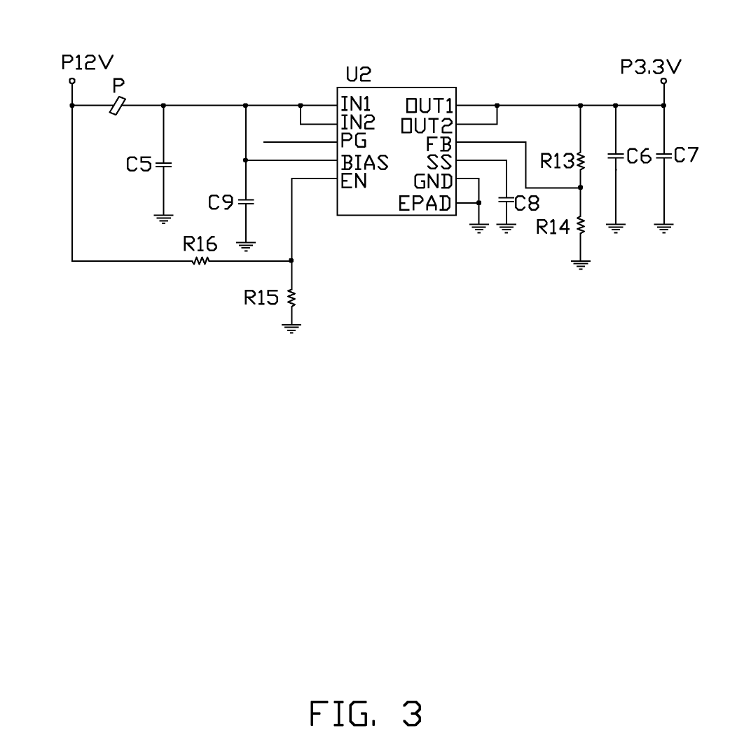

FIGS. 2 and 3 show that a control circuit 100 includes a first chip U1 and a second chip U2. The first chip U1 includes a first pin group having a plurality of pins PA0-PA4, a second pin group having a plurality of pins PC0-PC5, a third pin group having a plurality of pins PD0-PD6, a fourth pin group having a plurality of pins PB0-PB7, a reset pin RESET, a power pin VCC, a ground pin GND, first and second clock pins XTAL1 and XTAL2, and first to third data pins SDA, SCK, and RST.

The pins PA0-PA4 of the first pin group of the first chip U1 are connected to first to fifth switches K1-K5. For example, the pin PA0 of the first chip U1 is connected to a first switch K1, and the pin PA4 of the first chip U1 is connected to a fifth switch K5. The pins PC0 and PC1 of the second pin group of the first chip U1 are connected to the plurality of output circuits. The pins PC2-PC5 of the second pin group of the first chip U1 are connected to a first power source P5V through a plurality of resistors R1-R4. The pins PD0-PD6 of the third pin group of the first chip U1 are connected to the first power source P5V through a plurality of resistors R5-R11 and provide the first to fifth power-off signals Vout1_GD-Vout5_GD. The pins PB0-PB2 of the fourth pin group of the first chip U1 provide the first to third enable signals EN1-EN3, and the pins PB3-PB7 of the fourth pin group of the first chip U1 provide first to fifth power-on signals Vout1_EN-Vout5_EN. The rest pin RESET of the first chip U1 is connected to the first power source P5V through a resistor R12 and through capacitors C1 and C2, and grounded through the capacitor C1. The power pin VCC of the first chip U1 is connected to the first power source P5V, and the ground pin GND of the first chip U1 is grounded. The first clock pin XTAL1 of the first chip U1 is connected to a terminal of a clock chip X1, and grounded through a capacitor C3. The second clock pin XTAL2 of the first chip U1 is connected to the other terminal of the clock chip X1, and grounded through a capacitor C4. The first to third data pins SDA, SCK and RST of the first chip U1 are connected to the display circuit 160 for displaying output information of the first to third output circuits 110-130. In the embodiment the output information includes the first to fifth output voltages Vout1-Vout5 and first to fifth output currents of the first to third output circuits 110-130, the power-on sequence, and the power-off sequence.

The second chip U2 includes first and second input pins IN1 and IN2, first and second output pins OUT1 and OUT2, a feedback pin FB, ground pins SS, GDN, and EPAD, a power good pin PG, a bias pin BIAS, and an enable pin EN.

The first input pin IN1 of the second chip U2 is connected to one terminal of a ferrite bead P. The other terminal of the ferrite bead P is connected to a second power source P12V. The one terminal of the ferrite bead P is further grounded through a capacitor C5. The second input pin IN2 of the second chip U2 is connected to the first input pin IN1 of the second chip U2. The first and second output pins OUT1 and OUT2 of the second chip U2 is utilized as a third power source P3.3V for providing an input voltage of the output circuits. The first output pins OUT1 is grounded through a capacitor C6, through a capacitor C7, and through resistors R13 and R14. A node between the resistors R13 and R14 is connected to the feedback pin FB of the second chip U2. The ground pin SS of the second chip U2 is grounded through a capacitor C8. The ground pins GND and EPAD of the second chip U2 are grounded directly. The power good pin PG of the second chip U2 is connected to the pin PD5 of the first chip U1 to provide a power good signal P3.3V_GD. The bias pin BIAS of the second chip U2 is connected to the first input pin IN1 of the second chip U2 and grounded through a capacitor C9. The enable pin EN of the second chip U2 is grounded through a resistor R15, and connected to the second power source P12V through a resistor R16.

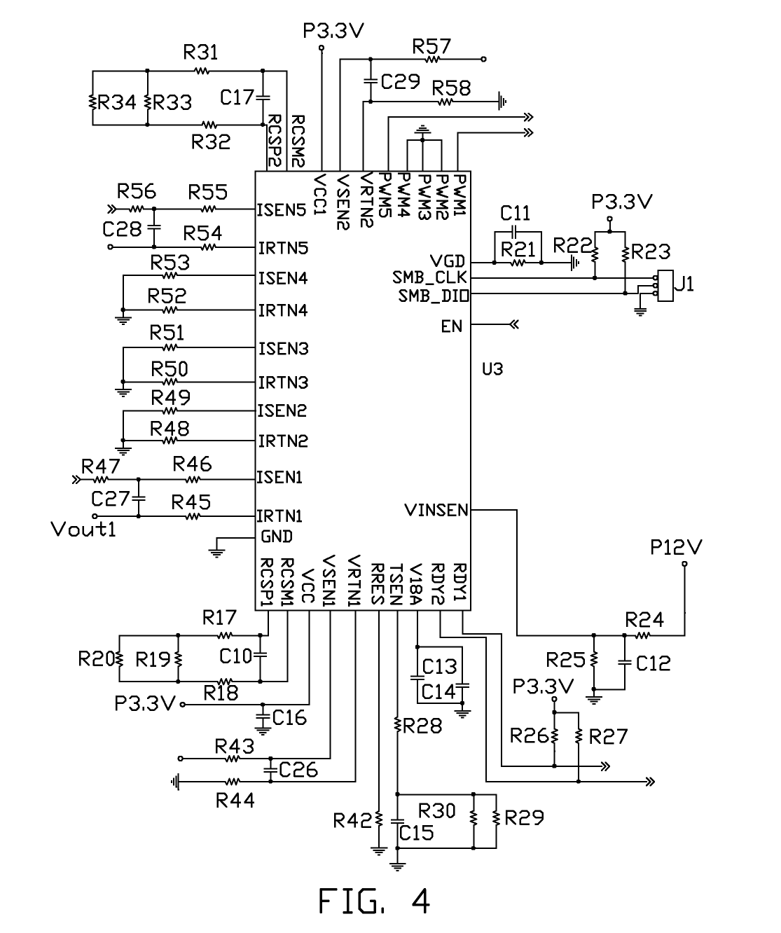

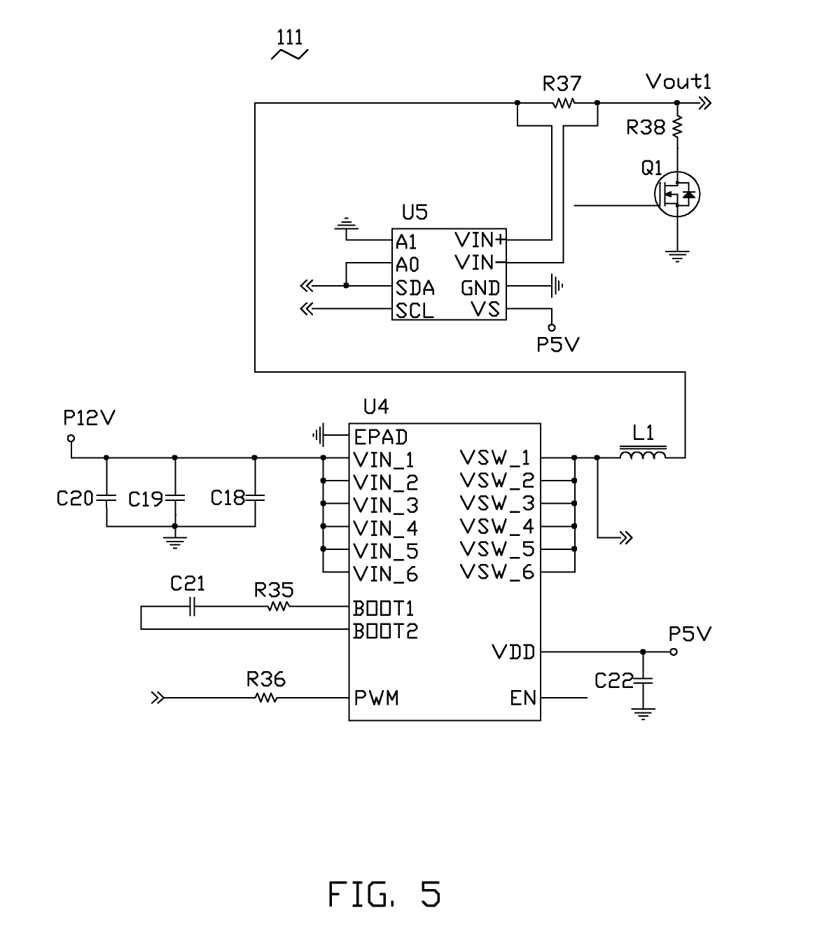

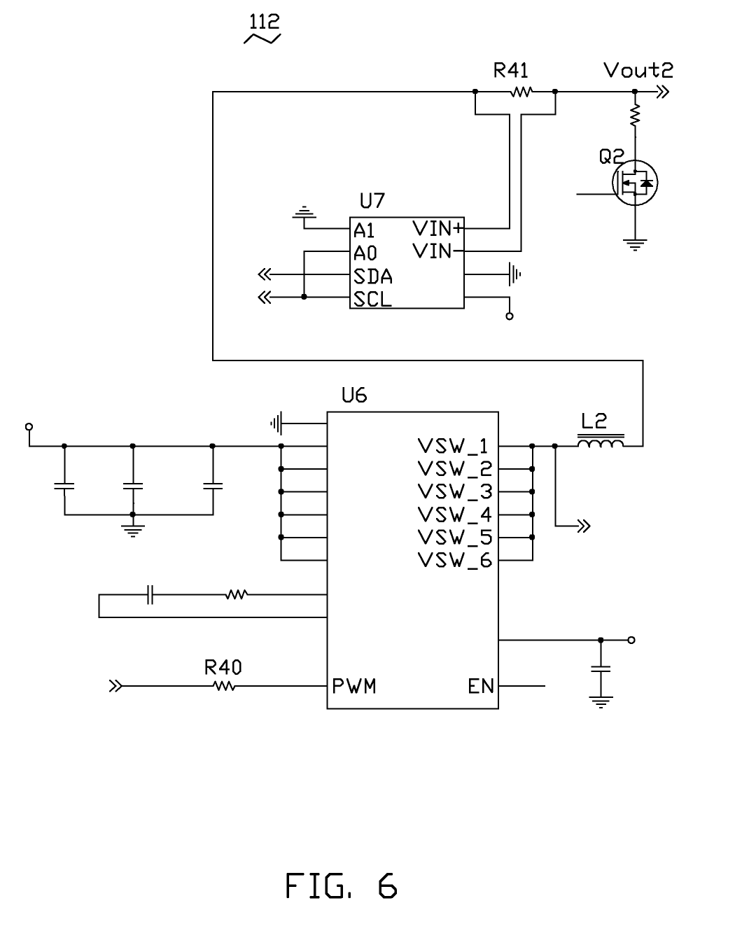

FIGS. 4-6 show that a first output circuit 110 includes a third chip U3, a first voltage circuit 111 having a fourth chip U4 and a fifth chip U5, and a second voltage circuit 112 having a sixth chip U6 and a seventh chip U7. The third chip U3 includes first and second voltage pins VCC1 and VCC, first to fourth clock pins RCSP1, RCSM1, RCSP2, and RCSM2, first to fifth pulse-width modulation (PWM) pins PWM1-PWM5, first to fifth ground pins VGD, V18A, TSEN, RRES, and GND, first and second bus pins SMB_CLK and SMB_DIO, an enable pin EN, a voltage sense pin VINSEN, and first and second power good pins RDY1 and RDY2.

The first voltage pin VCC1 of the third chip U3 is connected to the first output pin OUT1 of the second chip U2 to receive the third power source P3.3V. The first clock pin RCSP1 of the third chip U3 is connected to one terminal of a capacitor C10, and the second clock pin RCSM1 of the third chip U3 is connected to the other terminal of the capacitor C10. The first clock pin RCSP1 of the third chip U3 is further connected to the second clock pin RCSM1 of the third chip U3 through resistors R17, R18 and R19 and through the resistors R17-R18 and a resistor R20. The first and fifth PWM pins PWM1 and PWM5 of the third chip U3 provide first and second PWM signals, and the second to fourth PWM pins PWM2-PWM4 of the third chip U3 are grounded. The first ground pin VGD of the third chip U3 is grounded through a resistor R21 and through a capacitor C11. The first bus pin SMB_CLK of the third chip U3 is connected to the third power source P3.3V through a resistor R22, and connected to a first terminal of a first connecter J1. The second bus pin SMB_DIO of the third chip U3 is connected to the third power source P3.3V through a resistor R23, and connected to a second terminal of the first connecter J1. A third terminal of the first connector J1 is grounded. The first connecter J1 is connected to a bus interface so that the third chip U3 can be connected to other devices through the bus interface.

The enable pin EN of the third chip U3 is connected to the pin PB0 of the first chip U1 to receive the first enable signal EN1. The voltage sense pin VINSEN of the third chip U3 is connected to the second power source P12V through a resistor R24, and grounded through a resistor R25 and through a capacitor C12. The first power good pin RDY1 of the third chip U3 is connected to the third power source P3.3V through a resistor R26 to provide a first power good signal PWRGD1. The second power good pin RDY2 of the third chip U3 is connected to the third power source P3.3V through a resistor R27 to provide a second power good signal PWRGD2. In the embodiment, the feedback signal of the first output circuit 110 includes the first and second power good signals PWRGD1 and PWRGD2. The second ground pin V18A of the third chip U3 is grounded through a capacitor C13 and through a capacitor C14. The third ground pin TSEN of the third chip U3 is grounded through a resistor R28 and a capacitor C15. The capacitor C15 is connected in parallel to a resistor R29 and to a resistor R30.

The second voltage pin VCC of the third chip U3 is connected to the third power source P3.3V, and grounded through a capacitor C16. The third clock pin RCSP2 of the third chip U3 is connected to one terminal of a capacitor C17, and the fourth clock pin RCSM2 of the third chip U3 is connected to the other terminal of the capacitor C17. The third clock pin RCSP2 of the third chip U3 is further connected to the fourth clock pin RCSM2 of the third chip U3 through resistors R31, R32 and R33 and through the resistors R31 and R32 and a resistor R34.

The fourth chip U4 of the first voltage circuit 111 includes a ground pin EPAD, first to sixth input pins VIN_1-VIN_6, first and second boot pins BOOT1-BOOT2, a PWM pin PWM, a voltage pin VDD, an enable pin EN, and first to sixth output pins VSW_1-VSW_6. The fifth chip U5 of the first voltage circuit 111 includes first and second input pins VIN+ and VIN−, a ground pin GND, a voltage pin VS, first and second data pins SDA and SCL, and pins A0 and A1.

The ground pin EPAD of the fourth chip U4 is grounded. The first to sixth input pins VIN_1-VIN_6 of the fourth chip U4 are connected to the second power source P12V, and grounded through a capacitor C18, through a capacitor C19, and through a capacitor C20. The first boot pin BOOT1 of the fourth chip U4 is connected to the second boot pin BOOT2 of the fourth chip U4 through a resistor R35 and a capacitor C21. The PWM pin PWM of the fourth chip U4 is connected to the first PWM pin PWM1 of the third chip U3 through a resistor R36 to receive the first PWM signal for controlling a first value of the first output voltage Vout1 of the first voltage circuit 111 of the first output circuit 110. The voltage pin VDD of the fourth chip U4 is connected to the first power source P5V and grounded through a capacitor C22. The enable pin EN of the fourth chip U4 is connected to the pin PB3 of the first chip U1 to receive the first power-on signal Vout1_EN. The first to sixth output pins VSW_1-VSW_6 of the fourth chip U4 provide a first current detection signal Vout1_Isense for detecting a first output current of the first voltage circuit 111.

The first input pin VIN+ of the fifth chip U5 is connected to the first output pin VSW_1 of the fourth chip U4 through a first inductor L1, and connected to the second input pin VIN− of the fifth chip U5 through a resistor R37. The second input pin VIN− of the fifth chip U5 provides the first output voltage Vout1. In addition, the second input pin VIN− of the fifth chip U5 is connected to a first terminal of a first electronic switch Q1 through a resistor R38. A second terminal of the first electronic switch Q1 is grounded, and a third terminal of the first electronic switch Q1 is connected to the pin PD0 of the first chip U1 to receive the first power-off signal Vout1_GD. The ground pin GND of the fifth chip U5 is grounded. The voltage pin Vs of the fifth chip U5 is connected to the first power source P5V. The pin A1 of the fifth chip U5 is grounded. The pin A0 of the fifth chip U5 is connected to the first data pin SDA of the fifth chip U5. The first data pin SDA of the fifth chip U5 is connected to the pin PC0 of the first chip U1, and the second data pin SCL of the fifth chip U5 is connected to the pin PC1 of the first chip U1. In the embodiment, the first electronic switch Q1 is a first field-effect transistor (FET) having a first gate, a first drain, and a first source. The first terminal of the first electronic switch Q1 is the first drain of the first FET, the second terminal of the first electronic switch Q1 is the first source of the first FET, and the third terminal of the first electronic switch Q1 is the first gate of the first FET.

The pins of the sixth chip U6 are similar to those of the fourth chip U4, and the pins of the seventh chip U7 are similar to those of the fifth chip U5. In addition, the connection relationship between the sixth and seventh chips U6 and U7 is similar to that between the fourth and fifth chips U4 and U5. The PWM pin PWM of the sixth chip U6 is connected to the fifth PWM pin PWM5 of the third chip U3 through a resistor R40 to receive the second PWM signal for controlling a second value of the second output voltage Vout2 of the second voltage circuit 112 of the first output circuit 110. The enable pin EN of the sixth chip U6 is connected to the pin PB4 of the first chip U1 to receive the second power-on signals Vout2_EN. The output pins VSW_1-VSW_6 of the sixth chip U6 provide a second current detection signal Vout2_Isense for detecting a second output current of the second voltage circuits 112. The first input pin VIN+ of the seventh chip U7 is connected to the second input pin VIN− of the seventh chip U7 through a resistor R41, and connected to the first output pin VSW_1 of the sixth chip U6 through a second inductor L2. The second input pin VIN− of the seventh chip U7 provides the second output voltage Vout2. A third terminal of a second electronic switch Q2 is connected to the pin PD1 of the first chip U1 to receive the second power-off signal Vout2_GD. The pin A0 of the seventh chip U7 is connected to the second data pin SCL of the seventh chip U7.

The fourth ground pin RRES of the third chip U3 is grounded through a resistor R42. The fifth ground pin GND of the third chip U3 is grounded directly. In addition, the third chip U3 further includes first to fourth voltage detection pins VSEN1, VRTN1, VSEN2, VRTN2, and first to tenth current detection pins IRTN1-IRTN5 and ISEN1-ISEN5. The first voltage detection pin VSEN1 of the third chip U3 is connected to one terminal of a capacitor 26, and the second voltage detection pin VRTN1 of the third chip U3 is connected to the other terminal of the capacitor 26. The one terminal of the capacitor C26 is further connected to the first terminal of the first electronic switch Q1 through a resistor 43 to receive the first output voltage Vout1, and the other terminal of the capacitor C26 is further grounded through a resistor R44. The first current detection pin IRTN1 of the third chip U3 is connected to one terminal of a capacitor C27 through a resistor R45, and the sixth current detection pin ISEN1 of the third chip U3 is connected to the other terminal of the capacitor C27 through a resistor R46. The one terminal of the capacitor C27 is connected to the first terminal of the first electronic switch Q1 to receive the first output voltage Vout1, and the other terminal of the capacitor C27 is connected to the first output pin VSW_1 of the fourth chip U4 through a resistor R47 to receive the first current detection signal Vout1_Isense. The second to fourth current detection pins IRTN2-IRTN4 and the seventh to ninth current detection pins ISEN2-ISEN4 of the third chip U3 are grounded through resistors R48-R53. The fifth current detection pin IRTN5 of the third chip U3 is connected to one terminal of a capacitor C28 through a resistor R54, and the tenth current detection pin ISEN5 of the third chip U3 is connected to the other terminal of the capacitor C28 through a resistor R55. The one terminal of the capacitor C28 is connected to the first terminal of the second electronic switch Q2 to receive the second output voltage Vout2, and the other terminal of the capacitor C28 is connected to the first output pin VSW_1 of the sixth chip U6 through a resistor R56 to receive the second current detection signal Vout2_Isense. The third voltage detection pin VSEN2 of the third chip U3 is connected to one terminal of a capacitor 29, and the fourth voltage detection pin VRTN2 of the third chip U3 is connected to the other terminal of the capacitor 29. The one terminal of the capacitor C29 is further connected to the first terminal of the second electronic switch Q2 through a resistor 57 to receive the second output voltage Vout2, and the other terminal of the capacitor C29 is further grounded through a resistor R58.

In the embodiment, the second output circuit 120 is similar as the first output circuit 110. The second output circuit 120 provides third and fourth output voltages Vout3 and Vout4.

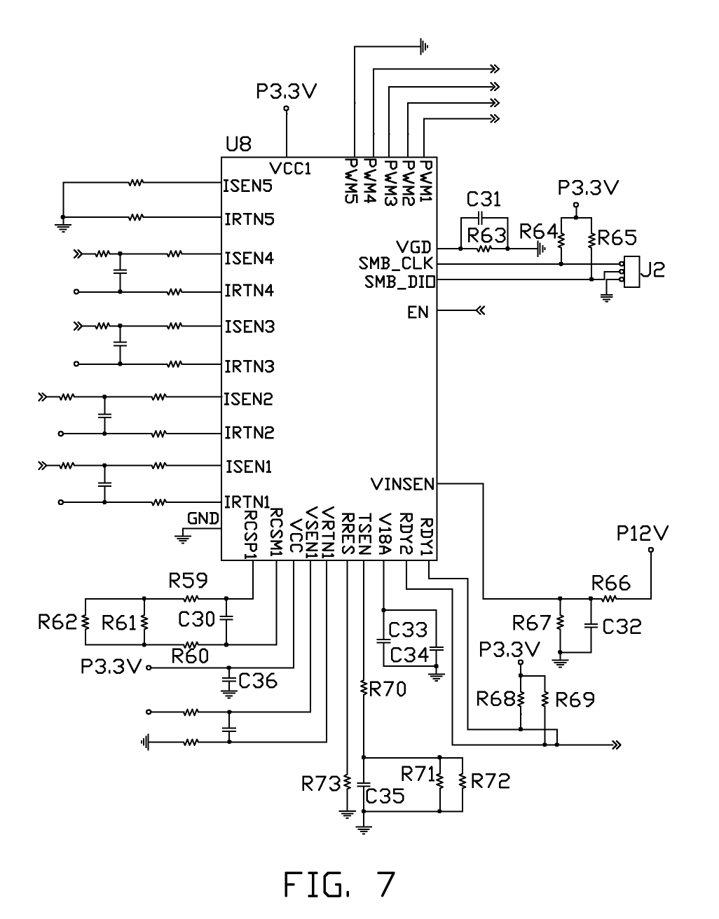

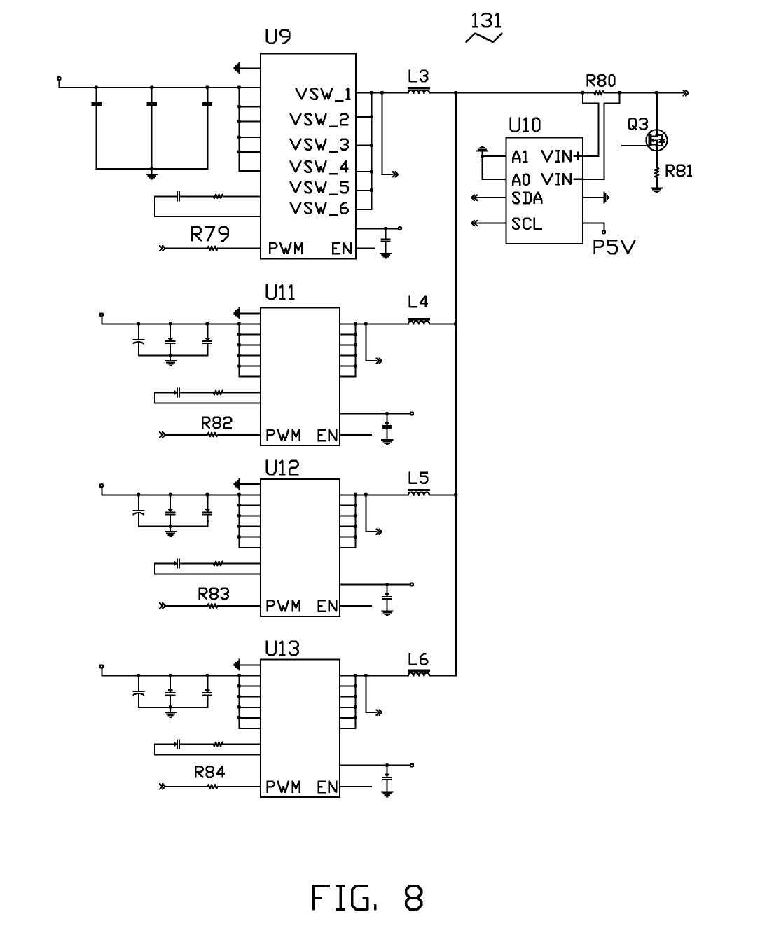

FIGS. 7 and 8 show that a third output circuit 130 includes an eighth chip U8 and a fifth voltage circuit 131 having ninth to thirteenth chips U9-U13. The eighth chip U8 includes first and second voltage pins VCC1 and VCC, first and second clock pins RCSP, RCSM, first to fifth pulse-width modulation (PWM) pins PWM1-PWM5, first to fifth ground pins VGD, V18A, TSEN, RRES, and GND, first and second bus pins SMB_CLK and SMB_DIO, an enable pin EN, a voltage sense pin VINSEN, and first and second power good pins RDY1 and RDY2.

The first voltage pin VCC1 of the eighth chip U8 is connected to the first output pin OUT1 of the second chip U2 to receive the third power source P3.3V. The first clock pin RCSP of the eighth chip U8 is connected to one terminal of a capacitor C30, and the second clock pin RCSM of the eighth chip U8 is connected to the other terminal of the capacitor C30. The first clock pin RCSP of the eighth chip U8 is further connected to the second clock pin RCSM of the eighth chip U8 through resistors R59, R60 and R61 and through the resistors R59-R60 and a resistor R62. The first to fourth PWM pins PWM1-PWM4 of the eighth chip U8 provide first to fourth PWM signals for controlling a third value of the fifth output voltage Vout5 of the third output circuit 130, and the fifth PWM pin PWM5 of the eighth chip U8 is grounded. The first ground pin VGD of the eighth chip U8 is grounded through a resistor R63 and through a capacitor C31. The first bus pin SMB_CLK of the eighth chip U8 is connected to the third power source P3.3V through a resistor R64, and connected to a first terminal of a second connecter J2. The second bus pin SMB_DIO of the eighth chip U8 is connected to the third power source P3.3V through a resistor R65, and connected to a second terminal of the second connecter J2. A third terminal of the second connector J2 is grounded. The second connecter J2 is connected to a bus interface so that the eighth chip U8 can be connected to other devices through the bus interface.

The enable pin EN of the eighth chip U8 is connected to the pin PB2 of the first chip U1 to receive the third enable signal EN3. The voltage sense pin VINSEN of the eighth chip U8 is connected to the second power source P12V through a resistor R66, and grounded through a resistor R67 and through a capacitor C32. The first power good pin RDY1 of the eighth chip U8 is connected to the third power source P3.3V through a resistor R68, and the second power good pin RDY2 of the eighth chip U8 is connected to the third power source P3.3V through a resistor R69. The first and second power good pins RDY1 and RDY2 of the eighth chip U8 are connected to each other to provide a fifth power good signal PWRGD5. The second ground pin V18A of the eighth chip U8 is grounded through a capacitor C33 and through a capacitor C34. The third ground pin TSEN of the eighth chip U8 is grounded through a resistor R70 and a capacitor C35. The capacitor C35 is connected in parallel to a resistor R71 and to a resistor R72.

The fourth ground pin RRES of the eighth chip U8 is grounded through a resistor R73. The second voltage pin VCC of the eighth chip U8 is connected to the third power source P3.3V, and grounded through a capacitor C36. The fifth ground pin GND of the eighth chip U8 is grounded directly.

The pins of the ninth chip U9 are similar to those of the fourth chip U4, and the pins of the tenth chip U10 are similar to those of the fifth chip U5. In addition, the connection relationship between the ninth and tenth chips U9 and U10 is similar to that between the fourth and fifth chips U4 and U5.

The PWM pin PWM of the ninth chip U9 is connected to the first PWM pin PWM1 of the eighth chip U8 through a resistor R79 to receive the first PWM signal of the eighth chip U8. The enable pin EN of the ninth chip U9 is connected to the pin PB7 of the first chip U1 to receive the fifth power-on signals Vout5_EN. The first to sixth output pins VSW_1-VSW_6 of the ninth chip U9 provide a fifth current detection signal Vout5-1_Isense.

The first input pin VIN+ of the tenth chip U10 is connected to the first output pin VSW_1 of the ninth chip U9 through a third inductor L3, and connected to the second input pin VIN− of the tenth chip U10 through a resistor R80. The second input pin VIN− of the tenth chip U10 provides the fifth output voltage Vout5. In addition, the second input pin VIN− of the tenth chip U10 is connected to a first terminal of a third electronic switch Q3. A second terminal of the third electronic switch Q3 is grounded through a resistor R81, and a third terminal of the third electronic switch Q3 is connected to the pin PD4 of the first chip U1 to receive the fifth power-off signal Vout5_GD. The pin A1 of the tenth chip U10 is grounded. The pin A0 of the tenth chip U10 is connected to the pin A1 of the tenth chip U10. The first data pin SDA of the tenth chip U10 is connected to the pin PC0 of the first chip U1, and the second data pin SCL of the tenth chip U10 is connected to the pin PC1 of the first chip U1. In the embodiment, the fifth voltage circuit 131 provides the fifth output voltage Vout5 when receiving the fifth power-on signal Vout5_EN and stops providing the fifth output voltage Vout5 through the third electronic switch Q3 when receiving the fifth power-off signal Vout5_GD.

The pins of the eleventh to thirteenth chip U11-U13 are similar to those of the ninth chip U9. In addition, each of the connection relationships between the eleventh and tenth chips U11 and U10, between the twelfth and tenth chips U12 and U10, and between the thirteenth and tenth chips U13 and U10 is similar to that between the ninth and tenth chips U9 and U10. The PWM pin PWM of the eleventh chip U11 is connected to the second PWM pin PWM2 of the eighth chip U8 through a resistor R82 to receive the second PWM signal, the PWM pin PWM of the twelfth chip U12 is connected to the third PWM pin PWM3 of the eighth chip U8 through a resistor R83 to receive the third PWM signal, and the PWM pin PWM of the thirteenth chip U13 is connected to the fourth PWM pin PWM4 of the eighth chip U8 through a resistor R84 to receive the fourth PWM signal. The first input pin VIN+ of the tenth chip U10 is connected to the first output pin VSW_1 of the eleventh chip U11 through a fourth inductor L4, connected to the first output pin VSW_1 of the twelfth chip U12 through a fifth inductor L5, and connected to the first output pin VSW_1 of the thirteenth chip U13 through a sixth inductor L6.

In addition, the eighth chip U8 further includes first and second voltage detection pins VSEN1 and VRTN1, and first to tenth current detection pins IRTN1-IRTN5 and ISEN1-ISEN5. Each of the connection relationships of the first and second voltage detection pins VSEN1 and VRTN1 of the eighth chip U8 is similar to that of the first and second voltage detection pins VSEN1 and VRTN1 of the third chip U3. Each of the connection relationships of the first to fourth and sixth to ninth current detection pins IRTN1-IRTN4 and ISEN1-ISEN4 of the eighth chip U8 are similar to those of the first and sixth current detection pins IRTN1 and ISEN1 of the third chip U3. Each of the connection relationships of the fifth and tenth current detection pins IRTN5 and ISEN5 of the eighth chip U8 are similar to those of the second and seventh current detection pins IRTN2 and ISEN2 of the third chip U3. In addition, the first to fourth current detection pins IRTN1-IRTN4 are connected to the first terminal of the third electronic switch Q3 to receive the fifth output voltage Vout5. The sixth to ninth current detection pins ISEN1-ISEN4 of the eighth chip U8 are connected to the first output pins VSW_1 of the ninth and eleventh to thirteenth chips U9 and U11-U13 to receive the fifth current detection signals Vout5-1_Isense-Vout5-4_Isense.

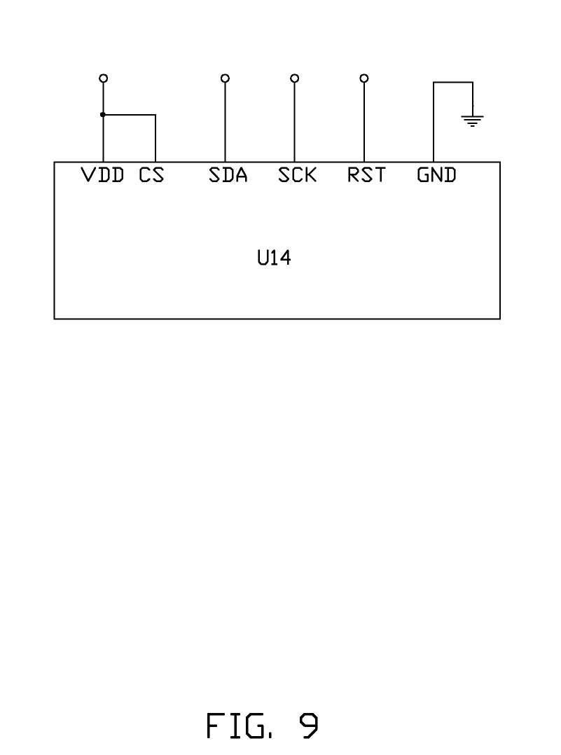

FIG. 9 shows that a display circuit 160 includes a fourteenth chip U14. The fourteenth chip U14 includes first and second voltage pins VDD and CS, first to third data pins SDA, SCK and RST, and a ground pin GND.

The first and second voltage pins VDD and CS are connected to each other, and connected to the first power source P5V. The first data pin SDA of the fourteenth chip U14 is connected to the first data pin SDA of the first chip U1, the second data pin SCK of the fourteenth chip U14 is connected to the second data pin SCK of the first chip U1, and the third data pin RST of the fourteenth chip U14 is connected to the third data pin RST of the first chip U1. The ground pin of the fourteenth chip U14 is grounded. The fourteenth chip U14 is utilized to show the first to fifth output voltages Vout1-Vout5 and the first to fifth output currents of the first to third output circuits 110-130 and to obtain power values according to the first to fifth output voltages Vout1-Vout5 and the first to fifth output currents. In addition, the fourteenth chip U14 is utilized to show the power-on and power-off time intervals between the first to fifth output voltages Vout1-Vout5, i.e. the power-on sequence and the power-off sequence of the first to fifth output voltage Vout1-Vout5.

An operating principle of the embodiment of the present disclosure is as follows.

During a power-on period, the first to fifth switches K1-K5 are adjusted to control an internal program of the first chip U1. For example, power-on time intervals between the output voltages Vout1-Vout5 are adjusted to be 10 milliseconds when the first to fifth switches K1-K5 are turned off. The first chip U1 operates according to the internal program of the first chip U1 so that the pins PB3-PB7 of the first chip U1 can provide the first to fifth power-on signals Vout1_EN-Vout5_EN according to the adjusted power-on time intervals. When the fourth chip U4 receives the first power-on signal Vout1_EN, the fifth chip U5 is controlled to provide the first output voltage Vout1. After a first one of the power-on time intervals has passed, the sixth chip U6 receives the second power-on signal Vout2_EN and the seventh chip U7 is controlled to provide the second output voltage Vout2. After a second one of the power-on time intervals has passed, the first chip U1 provides the third power-on signal Vout3_EN and the second output circuit 120 provides the third output voltage Vout3. After a third one of the power-on time intervals has passed, the first chip U1 provides the fourth power-on signal Vout4_EN and the second output circuit 120 provides the fourth output voltage Vout4. After a fourth one of the power-on time intervals has passed, the first chip U1 provides the fifth power-on signal Vout5_EN and the third output circuit 130 provides the fifth output voltage Vout5. The third output circuit 130 includes four phase synchronous rectifier so that the third output circuit 130 is utilized for supplying power to the load with a high current demand. In addition, the first chip U1 provides the first enable signal EN1 through the pin PB0 of the first chip U1 to control the first and fifth PWM pins PWN1 and PWM5 of the third chip U3 to provide the first and second PWM signals. The first chip U1 provides the second enable signal EN2 through the pin PB1 of the first chip U1 to control a chip of the second output circuit 120 to provide the PWM signals. The first chip U1 provides the third enable signal EN3 through the pin PB2 of the first chip U1 to control the first to fourth PWM pins PWM1-PWM4 of the eighth chip U8 to provide the first to fourth PWM signals.

The first output circuit 110 monitors in real time the first and second output voltages Vout1 and Vout2 and the first and second output currents through the resistors R37 and R41 and the fifth and seventh chips, and feeds back to the first chip U1. The first chip U1 measures powers according to the received output voltages and currents, and then provides the measured powers, the received voltages and currents, and the power-on sequence to the display circuit 160. In the embodiment, the second and third output circuits 120 and 130 also monitor the voltages and currents and feed them back to the first chip U1. The first chip U1 measures powers through the received voltages and currents of the second and third output circuits 120 and 130, and provides the measured powers, the received voltages and currents, and the power-on sequences of the second and third output circuits 120 and 130 to the display circuit 160.

During a power-off period, the first to fifth switches K1-K5 are adjusted to control the internal program of the first chip U1. For example, the power-off time intervals between the output voltages Vout1-Vout5 are adjusted to be 10 milliseconds when the first to fifth switches K1-K5 are turned on. The first chip U1 operates according to the internal program of the first chip U1 so that the pins PD0-PD5 of the first chip U1 can provide the power-off signals Vout1_GD-Vout5_GD according to the adjusted power-off time intervals. In the embodiment, the first to fifth power-off signals Vout1_GD-Vout5_GD are signals with high level potentials. A voltage between the first high level potential of the first power-off signal Vout1_GD and a ground potential is larger than threshold voltage of the first electronic switch Q1. Therefore, the first electronic switch Q1 can be turned on when the first electronic switch Q1 receives the first power-off signal Vout1_GD. Similarly, the second electronic switches Q2 can be turned on when the second electronic switch Q2 receives the second power-off signal Vout2_GD, and the third electronic switch Q3 can be turned on when the third electronic switch Q3 receives the fifth power-off signal Vout5_GD. In addition, the electronic switches in the second output circuit 120 can be turned on when the electronic switches in the second output circuit 120 receives the third and fourth power-off signals Vout3_GD and Vout4_GD.

When the first electronic switch Q1 is turned on, the first output terminal of the first output voltage 110 is grounded through the first electronic switch Q1 and stops providing the first output voltage Vout1. After a first one of the power-off time intervals has passed, the second electronic switch Q2 is turned on. The second output terminal of the first output voltage 110 is grounded through the second electronic switch Q2 and stops providing the second output voltage Vout2. When the first electronic switch of the second output circuit 120 is turned on, the first output terminal of the second output circuit 120 is grounded through the first electronic switch of the second output circuit 120 and stops providing the third output voltage Vout3. When the second electronic switch of the second output circuit 120 is turned on, the second output terminal of the second output circuit 120 is grounded through the second electronic switch of the second output circuit 120 and stops providing the fourth output voltage Vout4. When the third electronic switch Q3 is turned on, the output terminal of the third output voltage 130 is grounded through the third electronic switch Q3 and stops providing the fifth output voltage Vout5. In the embodiment, the first chip U1 provides the power-off sequences to the display circuit 160.

After the first to fifth output voltages Vout1-Vout5 are powered on, the motherboard is determined whether it can be started normally or not. If the motherboard is started normally, the power-on sequence of the motherboard is the power-on sequence set by the first to fifth switches K1-K5. If the motherboard cannot be started normally, the first to fifth switches K1-K5 can be adjusted to form another power-on sequence. For example, the first to fourth switches K1-K4 are turned off and the fifth switch K5 is turned on. Then, the motherboard is tested again. Thereby, the power-on sequence of the motherboard can be determined by adjusting the first to fifth switches K1-K5 to form different power-on sequences.

When the motherboard is started normally, the first to fifth switches K1-K5 are adjusted to control the power-off sequence of the first to fifth output voltages Vout1-Vout5. After the first to fifth output voltages Vout1-Vout5 are powered off, the first to fifth switches K1-K5 are adjusted to power on according to the determined power-on sequence. If the motherboard is started normally again, the power-off sequence of the motherboard is the power-off sequence set by the first to fifth switches K1-K5. If the motherboard cannot be started normally, the power-off sequence set by the first to fifth switches K1-K5 is inappropriate. Therefore, the first to fifth switches K1-K5 are adjusted again to try a new power-off sequence. Thereby, the power-off sequence of the motherboard can be determined by adjusting the first to fifth switches K1-K5 to form different power-off sequences.

While the disclosure has been described by way of example and in terms of various embodiments, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A power sequence circuit comprising:
a control circuit providing a plurality of power-on signals according to a power-on sequence and a plurality of power-off signals according to a power-off sequence; and
a plurality of output circuits, each of the plurality of output circuits provides an output voltage when receiving a corresponding one of the plurality of power-on signals, and stops providing the output voltage when receiving a corresponding one of the plurality of power-off signals.

2. The power sequence circuit of claim 1, further comprising:
a display circuit connected to the control circuit, wherein the control circuit detects the output voltages of the plurality of output circuits, and displays the power-on sequence, the power-off sequence, and the detected output voltages through the display circuit.

3. The power sequence circuit of claim 2, wherein each of the plurality of output circuits provides an output current when receiving a corresponding one of the plurality of power-on signals, and the control circuit detects the output currents of the plurality of output circuits and displays the detected output currents through the display circuit.

4. The power sequence circuit of claim 1, wherein the control circuit further comprises:
a first chip connected to the plurality of output circuits to transmit the plurality of power-on signals and the plurality of power-off signals, and connected to a display circuit to display output information of the plurality of output circuits; and
a second chip connected to the plurality of output circuits to provide an input voltage, and connected to the first chip to transmit a power good signal.

5. The power sequence circuit of claim 4, wherein a first one of the plurality of output circuits further comprises:
a third chip comprising a voltage pin, first to fifth pulse-width modulation (PWM) pins, and an enable pin, wherein the voltage pin of the third chip is connected to the second chip to receive the input voltage, the first PWM pin of the third chip transmits a first PWM signal, the fifth PWM pin of the third chip transmits a second PWM signal, the second to fourth PWM pins of the third chip are grounded, the enable pin of the third chip is connected to the first chip.

6. The power sequence circuit of claim 5, wherein the first one of the plurality of output circuits further comprises:
a fourth chip comprising a PWM pin, an enable pin, and a plurality of output pins, wherein the PWM pin of the fourth chip is connected to the first PWM pin of the third chip to receive the first PWM signal, the enable pin of the fourth chip is connected to the first chip, the plurality of output pins of the fourth chip transmit a first current detection signal to detect a first output current of the first one of the plurality of output circuits; and
a fifth chip comprising first and second input pins and first and second data pins, wherein the first input pin of the fifth chip is connected to the second input pin of the fifth chip through a first resistor and connected to the plurality of output pins of the fourth chip through a first inductor, the second input pin of the fifth chip provides a first output voltage of the first one of the plurality of output circuits and is connected to a drain of a first field-effect transistor (FET), a source of the first FET is grounded, a gate of the first FET is connected to the first chip to receive a first one of the plurality of power-off signals, the first and second data pins of the fifth chip are connected to the first chip.

7. The power sequence circuit of claim 5, wherein a first one of the plurality of output circuits further comprises:
a sixth chip connected to the fifth PWM pin of the third chip to receive the second PWM signal, wherein the sixth chip transmits a second current detection signal to detect a second output current of the first one of the plurality of output circuits; and
a seventh chip comprising first and second input pins and first and second data pins, wherein the first input pin of the seventh chip is connected to the second input pin of the seventh chip through a second resistor and connected to the sixth chip through a second inductor, the second input pin of the seventh chip provides a second output voltage of the first one of the plurality of output circuits and is connected to a drain of a second FET, a source of the second FET is grounded, a gate of the second FET is connected to the first chip to receive a second one of the plurality of power-off signals, the first and second data pins of the fifth chip are connected to the first chip.

8. The power sequence circuit of claim 1, wherein a first one of the plurality of output circuit comprises:
a third chip configured to receive a first enable signal from the control circuit;
a first voltage circuit connected to the third chip and providing a first output voltage of the first one of the plurality of output circuits; and
a second voltage circuit connected to the third chip and providing a second output voltage of the first one of the plurality of output circuits.

9. The power sequence circuit of claim 8, wherein the third chip provides a first PWM signal to the first voltage circuit according to the first enable signal to control a first value of the first output voltage of the first one of the plurality of output circuits, and the third chip provides a second PWM signal to the second voltage circuit according to the first enable signal to control a second value of the second output voltage of the first one of the plurality of output circuits.

10. The power sequence circuit of claim 8, wherein the first voltage circuit provides the first output voltage of the first one of the plurality of output circuits when receiving a first one of the plurality of power-on signals, and the second voltage circuit provides the second output voltage of the first one of the plurality of output circuits when receiving a second one of the plurality of power-on signals.

11. The power sequence circuit of claim 10, wherein the first voltage circuit stops providing the first output voltage through a first electronic switch when receiving a first one of the plurality of power-off signals, and the second voltage circuit stops providing the second output voltage through a second electronic switch when receiving a second one of the plurality of power-off signals.

12. The power sequence circuit of claim 1, wherein the control circuit receives a plurality of feedback signals from the plurality of output circuits, and determines according to the plurality of feedback signals whether the plurality of output circuits provide the output voltages or not.

13. The power sequence circuit of claim 1, wherein a second one of the plurality of output circuits comprises:
an eighth chip configured to receive a second enable signal from the control circuit; and
a third voltage circuit connected to the eighth chip and outputting an output voltage of the second one of the plurality of output circuit.

14. The power sequence circuit of claim 13, wherein the eighth chip outputs a plurality of third PWM signals to the third voltage circuit according to the second enable signal to control a third value of the output voltage of the second one of the plurality of output circuit, and the third voltage circuit outputs the output voltage of the second one of the plurality of output circuit when receiving a third one of the plurality of power-on signals and stops outputting the output voltage of the second one of the plurality of output circuit through a third electronic switch when receiving a third one of the plurality of power-off signals.

15. The power sequence circuit of claim 1, wherein the control circuit comprises a plurality of switches configured to adjust the power-on sequence and the power-off sequence.
